(19) United States
(12) Patent Application Publication
(10) Pub. No.: US 2020/0161009 A1
(43) Pub. Date: May 21, 2020

(54) SEAL PACKAGE FACE PLATE OF A SHAFT SEALING SYSTEM OF A REACTOR COOLANT PUMP

(71) Applicant: FRAMATOME, COURBEVOIE (FR)

(72) Inventor: Zoé TEBBY, HASPRES (FR)

(21) Appl. No.: 16/619,177

(22) PCT Filed: Jun. 8, 2018
(86) PCT No.: PCT/EP2018/065116

§ 371 Date: Dec. 4, 2019

(30) Foreign Application Priority Data
Jun. 8, 2017 (FR) 1755117

(51) Int. Cl. G21C 15/18; G21C 15/243; F16J 15/16

(52) U.S. Cl. CPC G21C 15/182; F16J 15/164; G21C 15/243

(57) ABSTRACT

A face plate (10, 11), made of silicon nitride, of a seal package (1) for a sealing system (4) of a shaft (7) of a reactor coolant pump in a nuclear reactor, is intended to ensure sealing between the primary circuit and the atmosphere. The face plate (10, 11) has an active surface covered by a protective layer (13) made from a nonporous material that is chemically inert to pressurized water superheated to a temperature greater than or equal to 200° C.

### TECHNICAL FIELD OF THE INVENTION

The invention relates to the field of primary reactor coolant pumps of pressurized water nuclear reactors (PWR).

More specifically, the invention relates to face plates, also called active faces, of the seal package of seal no. 1 of a shaft sealing system of a primary reactor coolant pump of a nuclear reactor.

### BACKGROUND OF THE INVENTION

In pressurized water reactors, the primary reactor coolant pump, also more simply called primary pump, sees to the circulation of water in the primary circuit of the reactor. A dynamic sealing system of the shaft ensures the sealing between the primary circuit and the atmosphere. This shaft sealing system of the primary reactor coolant pump is a controlled leak system. It includes three seals arranged in series. Each seal includes two face plates that ensure the main sealing. One of the face plates, called rotary face plate, is mounted in a rotating assembly secured to the shaft; the other face plate, called floating face plate, is mounted in an assembly that does not rotate, but that is free to move axially to follow any axial movements of the shaft.

Seal no. 1 ensures the majority of the pressure drop between the primary circuit and the atmosphere. It makes it possible to go from a pressure of 155 bars to a pressure of about 2 bars. This seal no. 1 is a seal of the hydrostatic type, with water film having a thickness of about 10 μm. The particular geometry of the faces of the face plates ensures the main sealing and allows, both stopped and rotating, an automatic adjustment of their separation.

Seal no. 1 works with a controlled leak rate, in the order of 600 liters per hour in nominal operation, owing to the specific profile machined on its active faces. The hot primary fluid is confined in the primary circuit owing to an injection of cold water upstream from seal no. 1 at a pressure slightly higher than that of the primary circuit. Part of this cold water passes in the primary circuit and part passes in seal no. 1 so as to cool it to maintain a temperature still below 100° C.

Historically, the face plates of seal no. 1 were made from alumina, but they are now most often made from silicon nitride, which better withstands friction.

In an accidental situation, of the SBO (Station Black Out) type, corresponding to a total loss of electrical power to the nuclear power plant, the cooling circuits of the shaft sealing system of the primary reactor coolant pump become inoperative and cause the loss of the high-pressure injection of cold water upstream from seal no. 1 and the cooling of the thermal barrier of the pump. As a result, the hot water from the primary circuit rises to the seals of the shaft sealing system.

During the study of these scenarios, the applicant identified that the passage of hot water between the silicon nitride face plates of seal no. 1 causes damage to them. Indeed, in an environment with water superheated to a temperature exceeding 200° C. and under pressure (pressure greater than or equal to the saturated vapor pressure of the water), which corresponds to an accidental situation of the SBO type, the silicon nitride face plates experience damage and decomposition. Indeed, under SBO its conditions, the silicon nitride turns into ammonia and silica. This results in a dissolution and erosion of the face plates, which lose surface material, the profile of the face plates therefore evolving and therefore causing a strong increase in the leak flow rate of seal no. 1, which no longer performs its function.

This situation is problematic, since it can quickly lead to the exposure of the core if the necessary palliative measures are not taken in time by the operator.

### BRIEF DESCRIPTION OF THE INVENTION

In this context, an effective solution is provided that is easy to implement, preventing the degradation of the silicon nitride face plates of seal no. 1 of the shaft sealing system of the primary reactor coolant pump of a nuclear reactor, in particular under accidental conditions involving loss of all of the cooling sources of the shaft seal system (SBO-type situation).

To that end, the surface of the face plates of seal no. 1 are covered with a specific protective layer imparting a hydrothermal protection to the silicon nitride, thus preventing it from dissolving under normal operating conditions and in an accidental situation of the SBO type.

More specifically, a face plate is provided, made of silicon nitride, for a sealing system of a shaft of a primary reactor coolant pump in a nuclear reactor intended to provide the sealing between the primary circuit and the atmosphere, said face plate having a surface covered by a protective layer made from a nonporous material that is chemically inert to superheated water at a temperature greater than or equal to 200° C. and under pressure (pressure greater than or equal to the saturated vapor pressure of the water).

An inert and non-degradable protective layer is used in an aqueous medium and under accidental conditions of the SBO type (temperature at the face plates greater than 200° C.), and capable of preventing the degradation and erosion of the surface of the silicon nitride face plates, which turns into silica under temperature conditions higher than 200° C. The protective layer withstands erosion under both normal operating conditions and conditions of the SBO type.

Owing to the addition of the protective layer on the silicon nitride face plates, the latter henceforth have a hydrothermal resistance to conditions of the SBO type and no longer suffer degradation.

Therefore, this protection against degradation of the nitride face plates responds to a specific issue, different from the issues of dirtying of the face plates known elsewhere.

The face plate according to the invention can also have one or several of the features below considered individually or according to all technically possible combinations:
the protective layer has adherence properties with the silicon nitride of said face plate;
the protective layer has chemical resistance properties to boric acid and/or lithium hydroxide and/or potassium hydroxide;
the protective layer has a homogeneous thickness; the protective layer has a uniform thickness and respects the shape of the support;
the protective layer has a hardness making it possible to withstand friction (in particular between the two active faces of the face plates) and scratches;
the protective layer has a roughness equivalent to the active surface of said face plate;
the protective layer has thermal shock resistance properties;
the protective layer is made from micro- or nanocrystalline diamond or zirconium oxide;
said protective layer has a thickness of several micrometers; for example between 0.1 and 30 micrometers and advantageously between 0.2 and 10 micrometers; and preferably between 0.2 and 2 μm;
the active surface of said face plate suitable for being in contact with a film of water is completely covered by a protective layer;
the protective layer withstands the erosion caused by water under normal conditions and accidental conditions of the SBO type;
the protective layer does not disrupt the normal operation of the face plate;
the protective layer withstands all of the conditions that seal no. 1 may experience during normal operation or in an accidental situation;
said face plate is a floating face plate or a rotary face plate.

A seal package is also provided including at least one of the face plates.

A shaft sealing system of a primary reactor coolant pump in a nuclear reactor is also provided including at least one of the seal packages.

A primary reactor coolant pump is also provided including the shaft sealing system.

A pressurized water reactor is also provided including the primary reactor coolant pump.

### BRIEF DESCRIPTION OF THE FIGURES

Other features and advantages of the invention will better emerge from reading the following description, in reference to the appended figures.

FIG. 1 is a sectional view of a shaft sealing system of a primary reactor coolant pump according to one embodiment of the invention.

FIG. 2 is a schematic sectional view of a seal no. 1 according to one embodiment of FIG. 1.

FIG. 3 is a schematic sectional view of the face plates of seal no. 1 according to one embodiment of the invention.

FIG. 4a is an image done by electron microscopy illustrating the surface state of a sample of the face plate of a seal no. 1 including a protective layer according to one embodiment of the invention after exposure to an aqueous medium at 290° C. and under pressure.

FIG. 4b is an image done by electron microscopy illustrating the surface state of the sample of the face plate of a seal no. 1 with no protective layer after exposure to an aqueous medium at 290° C. and under pressure.

FIG. 5a is a graph illustrating the evolution of the leak flow rate as a function of time of a seal no. 1 including face plates with the protective layer according to one embodiment of the invention, during an increase in the temperature at the seal no. 1 following a rise of the primary fluid under conditions of the SBO type.

FIG. 5b is a graph illustrating the evolution of the leak flow rate as a function of time of a seal no. 1 including face plates with no protective layer, during an increase in the temperature at the seal no. 1 following a rise of the primary fluid under conditions of the SBO type.

In all of the figures, like elements bear like references unless otherwise specified.

### DETAILED DESCRIPTION OF THE INVENTION

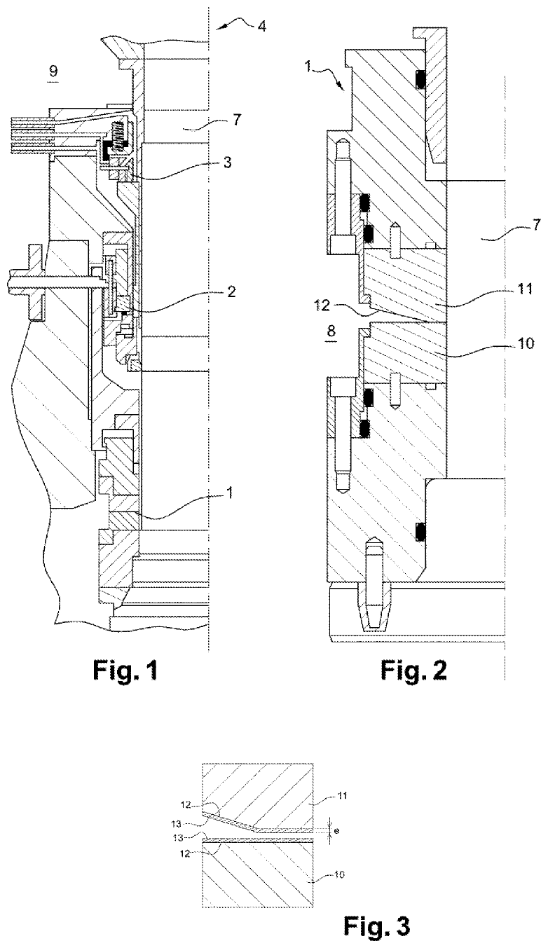

FIG. 1 shows a system of mechanical shaft 7 seal packages 4 of the primary reactor coolant pump of a pressurized water reactor. This shaft sealing system includes a seal no. 1 referenced 1 in FIG. 1, a seal no. 2 referenced 2 in FIG. 1 and a seal no. 3 referenced 3 in FIG. 1. Each seal no. 1, 2, 3 is made up of a rotary face plate secured on the shaft 7 and a floating face plate able to follow the axial movements of the shaft 7 but not rotating.

Seal no. 1 is shown more specifically in FIG. 2. Seal no. 1 ensures the majority of the pressure drop between the primary circuit 8 and the atmosphere 9. Seal no. 1 is of the hydrostatic type, with a water film having a thickness in the order of 10 μm. Seal no. 1 includes a rotary face plate 10 secured to the shaft 7 and a floating face plate 11 that can follow the axial movements of the shaft 7. The leak flow rate of seal no. 1 is determined by the double slope of the floating face plate 11 or by the respective slopes of the rotary and floating face plates according to an embodiment variant of the face plates of seal no. 1. The face plates 10,11 are made from silicon nitride.

The face plates 10, 11 of seal no. 1 are shown more specifically in FIG. 3. The surface 12 of at least one of the face plates 10, 11 is covered by a protective layer 13. Preferably, the two face plates 10 and 11 are covered by a protective layer 13 at their active face.

This protective layer 13 is made from a nonporous material that is chemically inert in an aqueous medium and at a temperature greater than or equal to 200° C. This protective layer 13 makes it possible to prevent the degradation and erosion of the surface of the silicon nitride face plates under conditions of the SBO type and does not disrupt the normal operation of seal no. 1.

The protective layer 13 also has properties of chemical resistance to corrosion and in particular boric acid, lithium hydroxide and potassium hydroxide, and withstands erosion. More generally, the protective layer 13 withstands all of the conditions that seal no. 1 may experience under normal operating conditions and under accidental conditions, and in particular under conditions of the SBO type for several hours, or even several days.

The protective layer 13 preferably has a thickness e of between 0.1 and 30 μm. The thickness of the protective layer e is preferably between 0.2 and 10 micrometers. Preferably, the protective layer 13 has a thickness e of between 0.2 and 2 micrometers.

The protective layer 13 is deposited uniformly with ad hoc means, that is to say, with a constant and homogeneous thickness while respecting the shape of the support.

The protective layer 13 has a great hardness and is suitable for withstanding scratches and the incidental friction that may occur between the two active faces of the face plates.

The protective layer 13 withstands substantial thermal shocks, such as the transition from a temperature of 15° C.-95° C. to a temperature greater than 200° C. in several seconds.

The protective layer 13 can be made from nano- or microcrystalline diamond, or from zirconium oxide.

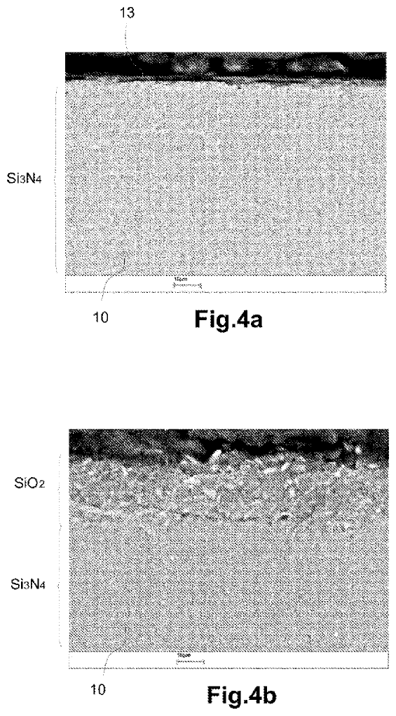

As a comparison, FIGS. 4a and 4b are two snapshots done by electron microscopy illustrating the surface state of the face plates with and without protective layer 13 after exposure to an aqueous medium at a temperature of 290° C. and under a pressure of 155 bars.

More specifically, FIG. 4a is a snapshot of a face plate of seal no. 1 including a protective layer 13 with a thickness of 2 μm, and FIG. 4b is a snapshot of a faceplate of seal no. 1 with no protective layer.

One can then easily see by comparison that the silicon nitride face plate with the protective layer 13 in FIG. 4a is intact, while the surface of the face plate without the protective layer in FIG. 4b is greatly degraded in terms of silica (SiO₂) over a thickness from several tens of micrometers to several hundreds of micrometers. Furthermore, the upper layer of silica dissolves with time, causing the degradation and dissolution of a greater height of silicon nitride face plate, in the order of several hundreds of micrometers.

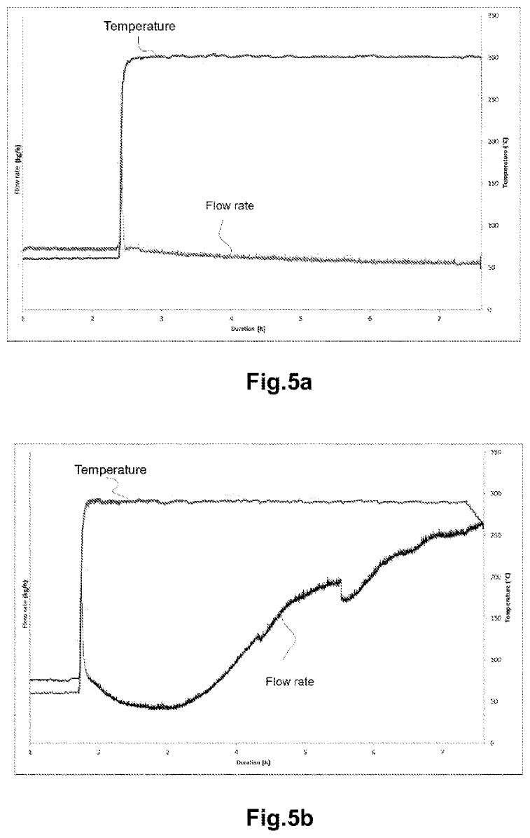

FIG. 5a is a graph illustrating the evolution of the leak flow rate as a function of time of a seal no. 1 including face plates with a protective layer 13 during an increase in the temperature of the primary fluid at seal no. 1. FIG. 5b is a graph illustrating the evolution of the leak flow rate as a function of time of a seal no. 1 including face plates with no protective layer during an increase in the temperature of the primary fluid at seal no. 1.

Thus, one can easily see the gain obtained with a protective layer 13. Indeed, in the graph of FIG. 5b, the face plates according to the state of the art with no protective layer deteriorate quickly following a significant change in temperature, which causes a strong increase in the leak flow rate of seal no. 1 in several hours. In comparison, the leak flow rate of seal no. 1 remains constant under the same conditions with the face plates including the protective layer 13.

Naturally, the invention is not limited to the embodiments described in reference to the figures, and variants may be considered without going beyond the scope of the invention. One may in particular use materials other than those cited in the detailed description as long as these materials are nonporous, inert and stable under conditions of the SBO type.

What is claimed is:

1-16. (canceled)

17. A face plate of a seal package for a sealing system of a shaft of a primary reactor coolant pump in a nuclear reactor, the face plate configured to provide the sealing between the primary circuit and the atmosphere, the face plate comprising:
a surface covered by a protective layer made from a nonporous material that is chemically inert to superheated water at a temperature greater than or equal to 200° C. and under pressure, the face plate being made of silicon nitride.

18. The face plate as recited in claim 17 wherein the protective layer has adherence properties with the silicon nitride of the face plate.

19. The face plate as recited in claim 17 wherein the protective layer has chemical resistance properties to boric acid and/or lithium hydroxide and/or potassium hydroxide.

20. The face plate as recited in claim 17 wherein the protective layer has a homogeneous thickness.

21. The face plate as recited in claim 17 wherein the protective layer has a hardness configured to withstand friction and scratches.

22. The face plate as recited in claim 17 wherein the protective layer has a roughness equivalent to an active surface of the face plate.

23. The face plate as recited in claim 17 wherein the protective layer has thermal shock resistance properties.

24. The face plate as recited in claim 17 wherein the protective layer is made from micro- or nanocrystalline diamond or zirconium oxide.

25. The face plate as recited in claim 17 wherein the protective layer has a thickness between 0.1 and 30 micrometers.

26. The face plate as recited in claim 17 wherein the protective layer has a thickness between 0.2 and 10 micrometers.

27. The face plate as recited in claim 17 wherein the protective layer has a thickness between 0.2 and 2 micrometers.

28. The face plate as recited in claim 17 wherein an active surface of the face plate configured for being in contact with a film of water is completely covered by the protective layer.

29. The face plate as recited in claim 17 wherein the protective layer is configured to withstand erosion caused by water under normal conditions and accidental conditions of the SBO type.

30. The face plate as recited in claim 17 wherein the face plate is a floating face plate or a rotary face plate.

31. A seal package comprising:
at least one of the face plate according to claim 17.

32. A sealing system of a shaft for a primary reactor coolant pump in a nuclear reactor comprising:
at least one of the seal package according to claim 31.

33. A primary reactor coolant pump of a nuclear reactor comprising:
the shaft sealing system according to claim 32.

34. A pressurized water reactor comprising:
the primary reactor coolant pump according to claim 33.
